(19) United States
(12) Patent Application Publication
(10) Pub. No.: US 2006/0157287 A1
(43) Pub. Date: Jul. 20, 2006

(54) Balance with a draft protection element

(75) Inventors: Roger Leisinger, Zurich (CH); Bruno Mattle, Uster (CH); Hansjuerg Rotach, Effretikon (CH); Patrik Morf, Naenikon (CH); Hansruedi Kuenzi, Greifensee (CH); Yves Marmier, La-Chaux-de-Fonds (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: METTLER-TOLEDO GMBH, Greifensee (CH)

(21) Appl. No.: 11/327,402

(22) Filed: Jan. 9, 2006

Related U.S. Application Data
(63) Continuation of application No. PCT/EP04/51355, filed on Jul. 5, 2004.

(30) Foreign Application Priority Data
Jul. 7, 2003 (DE) 103 30 788.5

(51) Int. Cl. G01G 21/28

(52) U.S. Cl. 177/180

(57) ABSTRACT

A balance with a balance housing serving to accommodate a weighing mechanism and weighing-related electronics is equipped with a weighing pan and with a draft protection element which can be loosely positioned on the balance housing and which surrounds the weighing pan. The balance housing is equipped with a step which serves to receive the draft protection element and whose seating surface for the draft protection element is arranged below the topside of the balance housing.

### RELATED APPLICATIONS

The present application is a continuation application which claims the benefit of the filing date of PCT/EP2004/051355, filed Jul. 5, 2004, under 35 U.S.C. §120, and claims priority under 35 U.S.C. §119 to German Patent Application No. 103 30 788.5, filed Jul. 7, 2003, the contents of which are hereby incorporated by reference in their entireties.

### BACKGROUND

A balance is disclosed with a balance housing serving to accommodate the weighing mechanism and the weighing-related electronics, with a weighing pan and with a draft protection element which can be loosely positioned on the balance housing, surrounding the weighing pan.

An exemplary use for balances of this kind is in laboratories, in the production environment or in stockrooms, and they are often optimized for a broad weighing range. These balances have a balance housing inside of which the weighing mechanism and the weighing electronics are arranged and in which a connecting element between the weighing pan and the weighing cell reaches through at least one opening at the topside of the balance housing. Balances of this kind are often equipped with a weighing pan that has a large surface. In order to reduce the influence that air drafts in the proximity of the weighing pan have on the weighing result, the balances are in most cases equipped with a draft protection device. Air drafts have a particularly strong effect in the space between the weighing pan and the top part of the balance housing, but state-of-the-art devices are known which serve to reduce these negative influences on the weighing result. However, the flexibility of such balances is in most cases strongly limited.

A balance with the trade designation “PR 8002” which is made and distributed by Mettler-Toledo GmbH has a draft protection element in the form of a ring which shields the gap between the top of the balance housing and the weighing pan. This ring has an approximately U-shaped profile and lies on a slightly slanted surface that ends flush with the level topside of the balance housing. The ring in this arrangement is held and constrained by means of a holder device in the form of holder lugs that engage ribs on the insides of the U-shaped profile.

This draft protection ring has the disadvantage that it needs to be carefully positioned due to the engagement with the holder. Furthermore, the holder lugs make the balance housing more difficult to clean.

A draft protection device is presented in JP 09-189597-A, which has the further purpose to avoid that insects could enter into the interior of the balance housing through the gap between the weighing pan and the balance housing. A saucer-shaped insert with upward-bent borders which cover the gap between the weighing pan and the balance housing is arranged at the topside of the balance housing. The surface of the insert that faces towards the weighing pan is provided with an appropriate means against insects.

The foregoing arrangement has the disadvantage that to clean the draft protection device one has to remove the weighing pan each time.

A balance is disclosed in DE 32 05 799, in which a screening device in the shape of a saucer which is spaced apart from the balance housing and from the weighing pan and reaches below the latter, where the saucer has a central opening for the passage of a connecting piece between the weighing pan and the weighing cell. The purpose of installing the saucer spaced apart from the topside of the balance housing has the purpose to protect the weighing pan against air currents that occur as a result of temperature differences due to the heat generated by the weighing electronics. A collar that is seated on the saucer has the purpose to act as a screen against further air currents which could enter the space between the weighing pan and the saucer. This device appears to have the problem that the space between the saucer and the topside of the balance housing is hard to reach for cleaning.

A balance which is disclosed in EP-A-0 574 668 has a draft protection housing with a top-covering wall that can be fastened as well as released by means of a manually operable locking device. After the top-covering wall has been taken off, it is possible to remove the front wall as well as the side walls completely from the housing for cleaning purposes. In this known embodiment, the top-covering wall is part of a frame that holds the draft protection housing together while keeping the walls below it to a certain extent free of connecting members and thus allowing a better view into the interior of the draft protection housing. Still, this draft protection device is not entirely satisfactory for many applications, because in the practical execution of the concept, a certain amount of manipulation is required on the locking devices, which have to be made with a high degree of precision so that they line up with the recesses in which they are received.

### SUMMARY

A balance is disclosed which in regard to using a draft protection element is flexible to operate and convenient to clean.

A balance with a balance housing serving to accommodate the weighing mechanism and the weighing-related electronics is equipped with a weighing pan and with a draft protection element which can be loosely positioned on the balance housing, surrounding the weighing pan, wherein the balance housing has a step which serves to receive the draft protection element and whose seating surface for the draft protection element is arranged below the topside of the balance housing.

A balance configured this way has an exemplary advantage that a means for reducing the influence of air drafts can be put in place on the balance housing in a fast and simple manner and that, as a result, the requirements on the accuracy of a weighing can be satisfied in a flexible manner.

In an exemplary embodiment, the balance housing is put together of a monolithically formed bottom part and a monolithically formed top part, with the step being formed in the top part. The step in this embodiment is advantageously distinguished by a largely horizontal seating surface with a width of at least 3 mm and a largely vertical positioning guide surface with a height of at least 5 mm. Thus, the balance has a particularly high level of cleaning convenience because the step can be cleared quickly and safely of spilled weighing material without getting too close to, or touching, the weighing pan. To take off the draft protection element, it is not necessary to remove the weighing pan.

In another exemplary embodiment, the draft protection element is a draft protection ring which conforms to the shape of the weighing pan. In another embodiment, if the requirements on the sensitivity of the balance are particularly high, the draft protection element is a draft protector body that surrounds the weighing pan and forms a weighing compartment. Thus, the balance housing has a modular design concept and is optimized so that it can receive the widest diversity of draft protection elements.

In an exemplary embodiment, the draft protection element has spacing means so that it can be positioned with an approximately uniform distance from the weighing pan. The spacing means contain (e.g., consist) for example, of a raised ledge around the internal circumference of the draft protection element, with projections arranged on the ledge.

The cleaning convenience of the balance is enhanced by the fact that the surface area that is exposed to the possibility of getting dirty is kept small if the substantially vertical surface areas of the draft protection device are arranged so that they are in flush alignment with the walls of the bottom part of the balance housing. In addition, this enhances the aesthetic appearance of the balance.

If no draft protection device is installed, a weighing pan with a large surface area can be connected to the balance, with a horizontal receiving surface for the weighing objects and with at least one largely vertical side surface, in an arrangement where the side surfaces of the weighing pan overlap the vertical positioning guide surfaces of the step in the balance housing and are in approximately flush alignment with the walls of the bottom part of the balance housing.

### BRIEF DESCRIPTION OF THE DRAWINGS

An exemplary balance will be explained hereinafter in more detail with references to an exemplary embodiment illustrated in the drawings, wherein

FIG. 1 shows a view of an exemplary balance and operating unit in a three-dimensional representation, a) without a draft protection element, and b) with a ring-shaped draft protection element;

FIG. 2 shows a side view of the exemplary balance, a) without a draft protection element, and b) with a ring-shaped draft protection element;

FIG. 3 represents a top view of the balance with a ring-shaped draft protection element;

FIG. 4 represents a sectional view of a part of the draft protection ring; and

FIG. 5 shows a further exemplary embodiment of the balance with a draft protection body seated in place, in a three-dimensional representation.

### DETAILED DESCRIPTION

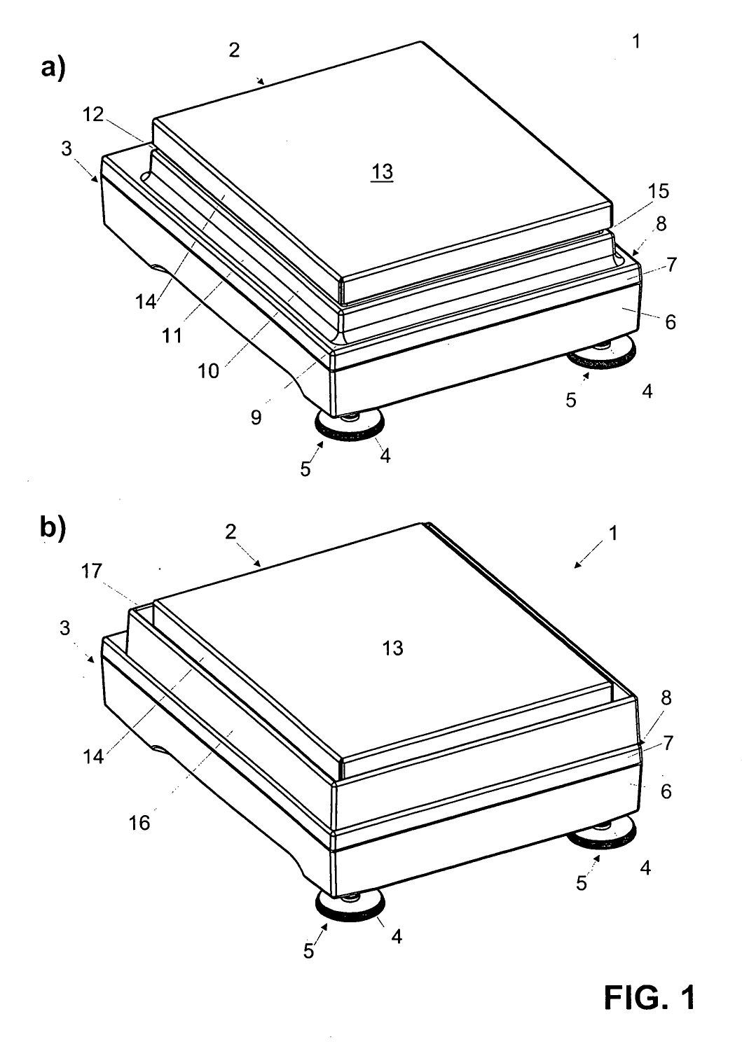

FIG. 1 shows a balance 1 of a type that can be found for example in a laboratory, in a production facility or in a stockroom. The balance 1 has a balance housing 3 containing a weighing cell (not visible in the drawing) and weighing electronics. The weighing pan 2 is connected to the weighing cell. In the illustrated example, the weighing pan extends nearly over the entire length and width of the balance housing 3. The balance 1 stands on three adjustable feet 5; the two adjustable feet at the front of the balance are visible in the drawing. Each of the adjustable feet 5 has a wheel 4 which allows a height adjustment of the respective foot 5 whereby the balance 1 is set to a level position. The height adjustment on each of the screw-threaded adjustable feet 5 is made by turning the respective foot 5 into or out of the balance housing 3.

FIG. 1a) shows the balance 1 without a draft protection element, so that the special shape of the balance housing 3 can be seen. The balance housing 3 contains (e.g., consists of) a monolithic tub-shaped bottom part 6, on which a monolithic top part 7 is seated and fastened to the bottom part 6, for example by means of screws. In the assembled state, the respective vertical wall surfaces of the top part 7 and the bottom part 6 are lined up flush with each other. A step 8 with an approximately horizontal seating surface 9 and a vertical positioning guide surface 10 extends all the way around the periphery of the top part 7. The horizontal seating surface 9 and the vertical positioning guide surface 10 meet each other in a rounded transition area 11. The top part 7 of the housing 3 is closed off on top by a horizontal top-covering wall 12 representing the topside of the balance housing, so to speak, which has either one opening in the middle (not visible in the drawing, because the opening is arranged below the weighing pan) or four openings near the corners of the top part (likewise invisible here) as passages for the connecting elements that connect the weighing pan 2 with the weighing cell.

The weighing pan 2 is rectangular and has a horizontal receiving surface 13 to receive the weighing objects and vertically downward-bent side portions 14 which give it the shape of a hollow box that is open on one side. The edges of the weighing pan 2 are rounded. The side portions 14 of the weighing pan 2 line up about flush with the vertical positioning guide surface 10, leaving a gap 15 between the weighing pan 2 and the vertical positioning guide surface 10, and also between the weighing pan 2 and the top-covering wall 12, so that the gap 15 provides the free range of movement which the weighing pan 2 needs for the weighing process.

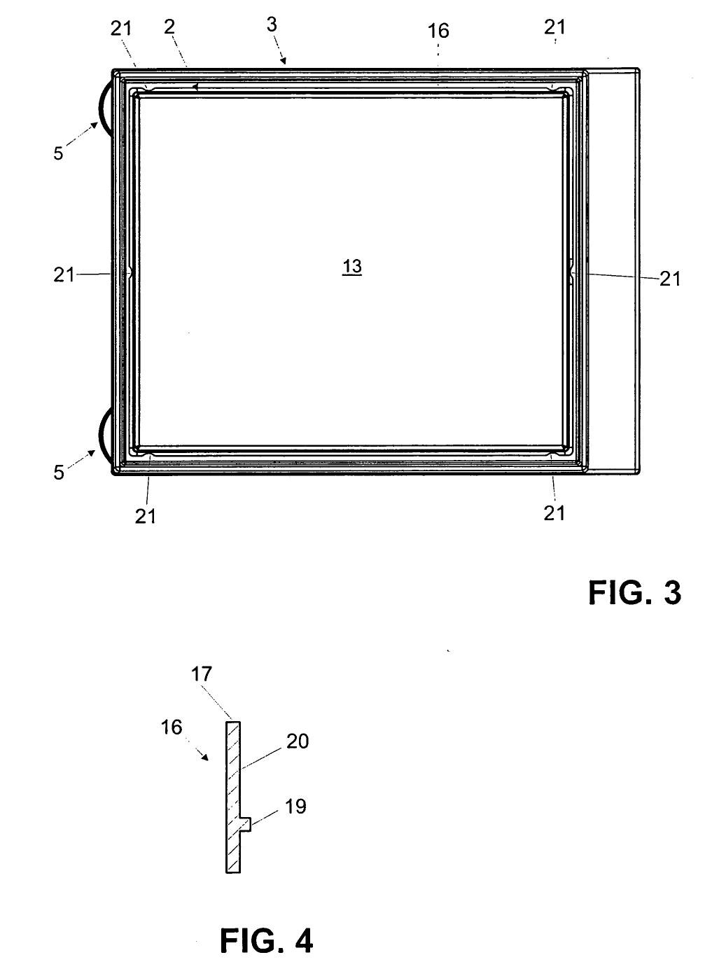

The step 8 serves as seating surface for a draft protection element which is designed as a draft protection ring 16 whose shape conforms to the shape of the weighing pan 2. This draft protection ring 16 is seated loosely on the step 8, maintaining on all four sides an approximately equal distance to the weighing pan 2, as the draft protection ring 16 is equipped with space holders as will be described farther below in the context of FIG. 3. In an exemplary embodiment, an essential function of the draft protection ring 16 is to provide a protective screen over the gap 15 between the weighing pan 2 and the top-covering wall 12 of the balance housing 3 and thereby to make the balance 1 insensitive against being influenced by air drafts in this particularly susceptible area.

The top edge 17 of the draft protection ring 16 lies a few millimeters below the level of the receiving surface 13 of the weighing pan 2, so that weighing objects extending beyond the confines of the weighing pan 2 will not come into contact with the draft protection ring 16. However, keeping the top edge 17 below the level of the receiving surface 13 is not always necessary; thus, a draft protection element is also conceivable in the form of a draft protection ring that is taller than the level of the receiving surface 13 for the weighing objects. The substantially vertical external surfaces of the draft protection 16 are arranged in flush alignment with the vertical walls of the bottom part 6 of the balance housing 3.

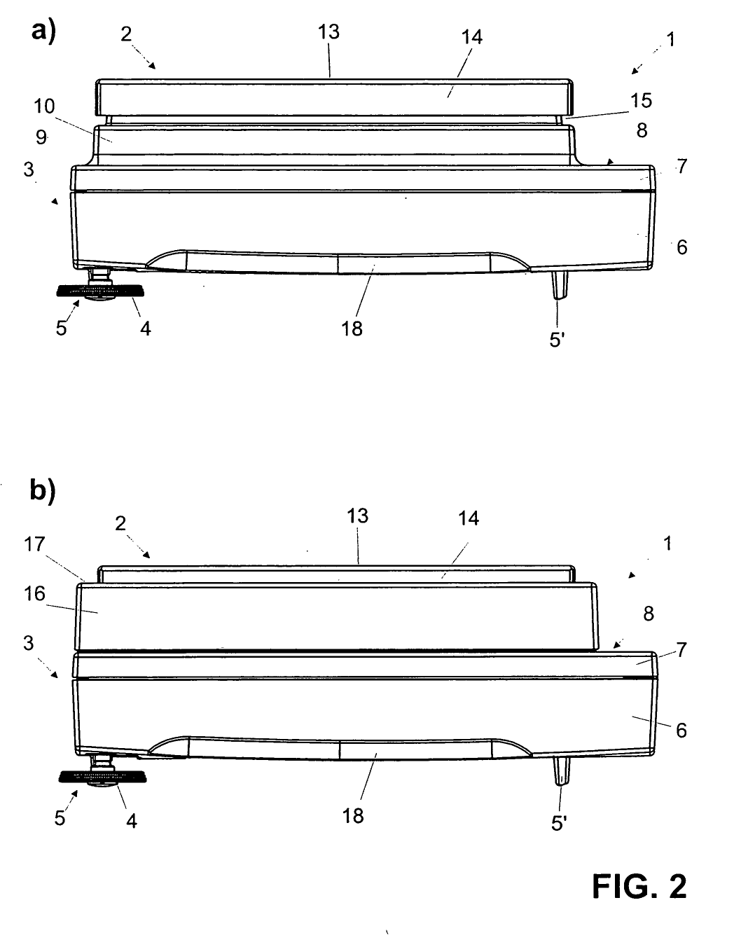

FIG. 2 shows a balance 1 in side view, a) without draft protection element, and b) with a draft protection ring 16 installed. As can be seen in this illustration, the end of the balance that faces the user (on the left-hand side of the drawing) rests on two height-adjustable feet 5 (only one of which is visible), while the rearward end (on the right-hand side of the drawing) rests on a third support element 5′. The balance 1 is equipped on both sides with recessed handgrips 18 to facilitate lifting of the balance 1 from its resting place. As can be seen in FIGS. 2a) and 2b), the step 8 is elongated in the rear part of the balance 1, which offers the possibility to install a further draft protection element, specifically a draft protection body with a rear wall of the type shown in FIG. 5.

The height of the step 8 as well as the largely horizontal seating surface 9 of step 8 are optimized in their respective dimensions with the aim of providing the balance housing 3, the weighing pan 2 as well as a corresponding draft protection element with a sufficiently high degree of stiffness, so that the aforementioned parts can be matched to each other without changing their shapes due to a possible forced deformation. The horizontal seating surface 9 has a width of at least 3 mm, and the vertical positioning guide surface 10 has a height of at least 5 mm.

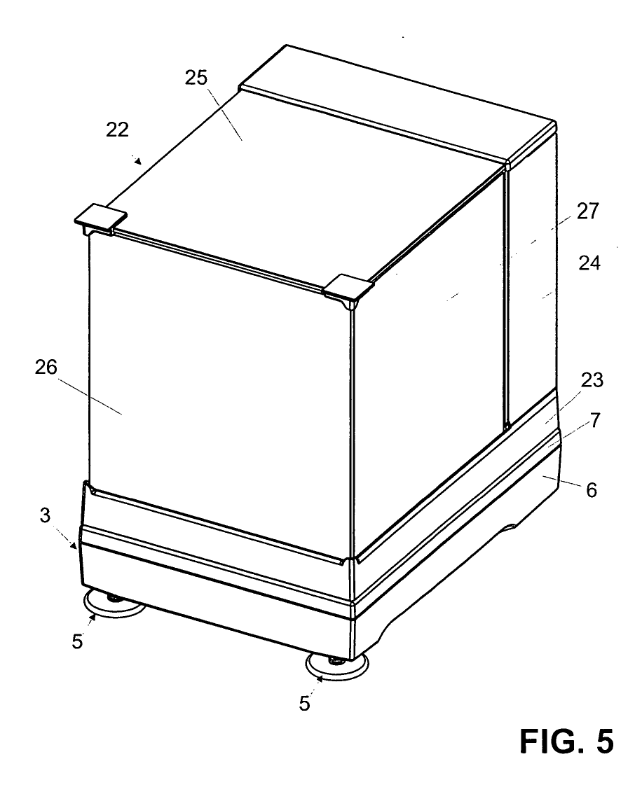

FIG. 3 shows the balance 1 as seen from above with a draft protection ring 16 set in place on the step 8. Each section of the draft protection ring 16 has a profile as shown in FIG. 4 with a raised ledge 19 extending all around the inside 20 of the ring. This makes it possible to put the draft protection ring 16 in place with an approximately uniform distance on all sides from the weighing pan 2. In addition, as shown in FIG. 3, the raised ledge 19 has space-holding projections 21 in six places, which in the installed condition of the draft protection ring seat themselves against the vertical positioning guide surface 10 with little play, thus strongly constraining any movement of the draft protection ring 16.

It is also possible, instead of the draft protection ring 16, to set other draft protection elements on the step 8, for example a loosely seated draft protection body 22 of the type illustrated in FIG. 5. The draft protection body 22 is equipped with a base 23 which can for example be put over the top-covering wall 12 and the vertical positioning guide surface 10 of the top part 7 and which is likewise equipped with at least one opening for the connection of the weighing pan 2 to the weighing cell. In the rearward part of the balance 1, a chamber 24 is arranged on the base 23 and thus completes the enclosure of a weighing compartment that has been created inside the draft protection body 22, with one side of the chamber 24 forming the rear wall of the weighing compartment. The draft protection body 22 includes further elements surrounding the weighing compartment, i.e., a lid 25 hinged on the chamber 24, a front element 26 and two side elements 27 (only one of which is visible in the drawing), which have either fixed or releasable connections with the draft protection body 22.

Many kinds of further draft protection elements are possible which share the common trait that they can be loosely seated on the step 8. For example, a draft protection element of the type shown in FIG. 5 does not necessarily have to be equipped with a chamber 24. In an exemplary balance according to the invention and meeting the foregoing description, it is also possible to install no draft protection element at all, equipping the balance 1 instead with a large weighing pan. The weighing pan can in this case have horizontal dimensions extending beyond the step 8, and the sides of the weighing pan can be substantially in flush alignment with the vertical side walls of the bottom part 6 of the balance housing 3. It is considered self-evident that the weighing pan is not limited to a rectangular shape.

The different configurations lend a large measure of modularity and flexibility to the balance 1 and ensure a setup conforming to the needs and areas of application of a user, while allowing the balance to be reconfigured without tools.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. Balance comprising:
a balance housing that serves to accommodate a weighing mechanism and a weighing-related electronics and which, when the balance is set up in an operating position, is closed off by a horizontal top-covering wall constituting a topside of the balance housing;
a weighing pan; and
a draft protection element which can be loosely positioned on the balance housing and which surrounds the weighing pan, wherein the balance housing is equipped with a step which serves to receive the draft protection element and whose largely horizontal seating surface for the draft protection element is offset in a vertical direction relative to the horizontal top-covering wall.

2. Balance according to claim 1, wherein the balance housing includes a monolithically formed bottom part and a monolithically formed top part, and wherein the step is formed in the top part.

3. Balance according to claim 2, wherein the largely horizontal seating surface of the step has a width of at least 3 mm, and the step has a largely vertical positioning guide surface with a height of at least 5 mm.

4. Balance according to claim 1, wherein the draft protection element is a draft protection ring which is adapted to conform to a shape of the weighing pan.

5. Balance according to claim 1, wherein the draft protection element is a draft protection body that surrounds the weighing pan and forms a weighing compartment.

6. Balance according to claim 1, wherein the draft protection element has spacing means such that the draft protection element can be positioned with a substantially uniform distance to the weighing pan.

7. Balance according to claim 6, wherein the spacing means comprise a raised ledge extending all around an inside of the draft protection element, and further comprise space-holding projections arranged on the raised ledge.

8. Balance according to claim 2, wherein the substantially vertical surface areas of the draft protection element are arranged in flush alignment with the walls of the bottom part of the balance housing.

9. Balance according to claim 3, wherein when no draft protection element is installed, a weighing pan that has a large surface area, with a horizontal receiving surface for weighing objects and with at least one largely vertical side surface, can be set in place, wherein said at least one side surface covers the vertical positioning guide surface of the step, and is arranged substantially in flush alignment with walls of the bottom part of the balance housing.

10. Balance according to claim 3, wherein the draft protection element is a draft protection ring which is adapted to conform to a shape of the weighing pan.

11. Balance according to claim 3, wherein the draft protection element is a draft protection body that surrounds the weighing pan and forms a weighing compartment.

12. Balance according to claim 3, wherein the draft protection element has spacing means such that the draft protection element can be positioned with a substantially uniform distance to the weighing pan.

13. Balance according to claim 12, wherein the spacing means comprise a raised ledge extending all around an inside of the draft protection element, and further comprise space-holding projections arranged on the raised ledge.

14. Balance according to claim 5, wherein the draft protection element has spacing means such that the draft protection element can be positioned with a substantially uniform distance to the weighing pan.

15. Balance according to claim 3, wherein the substantially vertical surface areas of the draft protection element are arranged in flush alignment with the walls of the bottom part of the balance housing.

16. Balance according to claim 5, wherein the substantially vertical surface areas of the draft protection element are arranged in flush alignment with the walls of the bottom part of the balance housing.
